(19) United States
(12) Patent Application Publication
(10) Pub. No.: US 2015/0127484 A1
(43) Pub. Date: May 7, 2015

(54) ENHANCED TRANSACTION CENTER LOCATOR

(71) Applicant: Bank of America Corporation, Charlotte, NC (US)

(72) Inventors: Tyler R. Johnson, Tega Cay, SC (US); James David Freedman, Charlotte, NC (US); Nathan Dent, Concord, NC (US)

(73) Assignee: Bank of America Corporation, Charlotte, NC (US)

(21) Appl. No.: 14/070,651

(22) Filed: Nov. 4, 2013

(51) Int. Cl. G06Q 30/06

(52) U.S. Cl. CPC G06Q 30/0639
USPC 705/26.9

(57) ABSTRACT

Methods, systems, computer-readable media, and apparatuses for receiving and processing location information requests are presented. In some embodiments, a decision engine may aggregate location service information and transaction center status information. The location service information may identify one or more services that are available at each of a plurality of enterprise locations, and the transaction center status information may identify a current status of one or more transaction centers at each of the plurality of enterprise locations. Subsequently, the decision engine may receive, from a user device, a data request for a location to perform a defined service, and the data request may include location information for the user device at the time of the data request. In response to receiving the data request, the decision engine may provide one or more options to the user device based on the location service information and the transaction center status information.

### BACKGROUND

Aspects of the disclosure relate to computer hardware and software. In particular, one or more aspects of the disclosure generally relate to computer hardware and software for receiving and processing location information requests.

Locator applications are commonly provided by commercial entities to provide information to individuals including commercial address information, hours of operation, and the like. A locator application may be accessed on a variety of devices (e.g., mobile devices, such as smart phones, tablet computers, and other types of mobile computing devices, desktop computing devices, and the like) and may be designed for a variety of operating systems. Certain aspects of such a locator application may vary across different implementations for different devices and operating systems, however. For example, if a user accesses the locator application from his or her mobile device, and later accesses the same locator application from his or her personal computer, the user may encounter and have to adjust to differences between the mobile device locator application and the personal computer locator application. Such differences may make it difficult for a user to navigate within the locator application and access the information that the user may be seeking

### SUMMARY

Aspects of the disclosure provide effective, efficient, and convenient ways of receiving and processing location information requests for defined services. In particular, certain aspects of the disclosure provide techniques for receiving and processing location information requests for a defined service and transmitting options to a user device in response to a received location information request.

For example, some aspects of the disclosure provide ways of aggregating different types of information at a decision engine, such as location service information and/or transaction center information, and subsequently processing data requests received from various user devices, where the data requests include requests for locations at which particular users can access and receive specific services that may be offered and/or provided by an organization implementing and/or deploying the location engine.

By providing decision engines and locator applications in accordance with one or more aspects of the disclosure, an organization may enable customers and other users to request and obtain location information, including information about transaction centers at which such customers and other users may obtain services provided by the organization. For instance, by having a decision engine generate location specific information in response to a request from a user device for the performance of specific services, as discussed below, an organization may enable a user to identify and receive location information for a transaction center which provides those specific services.

Thus, in some embodiments discussed below, a decision engine may aggregate location service information and transaction center status information. The location service information may identify one or more services that are available at each of a plurality of enterprise locations, and the transaction center status information may identify a current status of one or more transaction centers at each of the plurality of enterprise locations. The one or more services may include at least one of banking services (which may, e.g., include receiving a check deposit, receiving a cash deposit, issuing a cash withdrawal, receiving a request for a cashier's check, and the like), loan services (which may, e.g., include processing a home equity loan request, processing a car loan request, processing a home mortgage request, and the like), and administrative services (which may, e.g., include receiving a request for a new bank card, receiving a request to modify a bank account holder's account profile account, and the like). Subsequently, the decision engine may receive, from a user device, a data request for a location to perform a defined service. For example, such a data request may be composed by a customer of the organization that has implemented and/or deployed the decision engine, and the data request may represent a request submitted by the customer to find a retail location where the customer can obtain one or more specific services that are offered by and/or provided by the organization (which may, e.g., be referred to as “defined services” throughout this disclosure and may include one or more of the services discussed herein, including banking services, loan services, administrative services, and/or other services). Additionally, in response to receiving such a data request, the decision engine may provide one or more options to the user device based on the location service information and the transaction center status information. For instance, based on receiving a request from a particular user device for a location to perform a specific service, such as a specific loan service, the decision engine may provide the user device with information about a specific location that is within a predetermined distance of the current location of the user device and capable of and/or available to provide the specific service (e.g., the specific loan service in this example) to a user of the user device.

In some instances, the decision engine may provide one or more options to a user device based on the location service information, the transaction center status information and one or more business rules. The transaction center(s) about which information is provided may, in some instances, include automated teller machines (ATM), automated teller assistance (ATA) devices, banking centers, and/or the like.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented;

FIG. 1B illustrates another example operating environment in which various aspects of the disclosure may be implemented;

FIG. 2 illustrates an example of a system for receiving and processing location information requests according to one or more embodiments;

FIG. 3 illustrates a flowchart that depicts a method of receiving and processing location information requests according to one or more embodiments;

FIG. 4 illustrates an example of a user interface that may be displayed on a user device when a user composes a data request in one or more embodiments; and

FIG. 5 illustrates an example of a user interface that may be displayed on a user device upon receiving the provided options from a decision engine in one or more embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

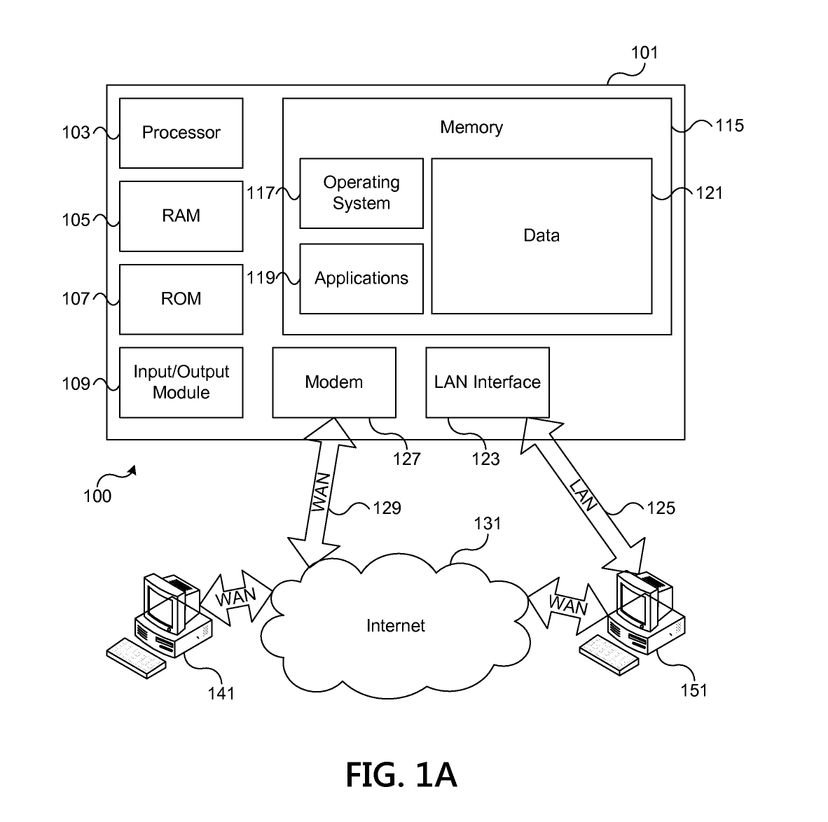

As noted above, certain embodiments are discussed herein that relate to receiving and processing location information requests. Before discussing these concepts in greater detail, however, an example of a computing device that can be used in implementing various aspects of the disclosure, as well as an example of an operating environment in which various embodiments can be implemented, will first be described with respect to FIGS. 1A and 1B.

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, and so on) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network

(LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail. As introduced above, some aspects of the disclosure generally relate to receiving and processing location information requests. In the discussion below, various examples illustrating how location information requests for various services may be received and processed using a decision engine in accordance with one or more embodiments will be provided.

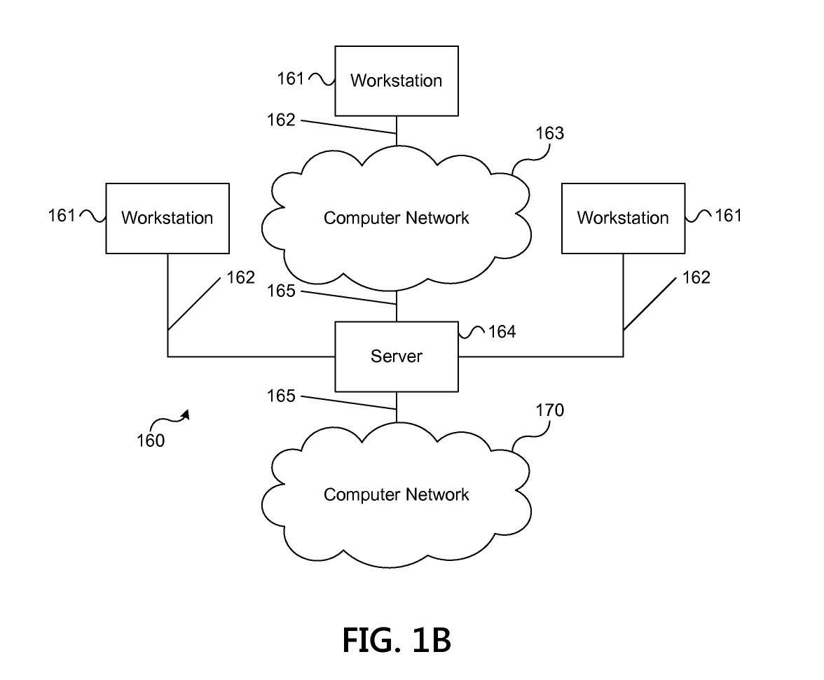

FIG. 2 illustrates an example of a system 200 for receiving and processing location information requests according to one or more embodiments. In some embodiments, system 200 may be implemented in one or more computing devices, which may include and/or incorporate one or more processors, one or more memories, and/or one or more aspects of the computing device 101 discussed above. In some instances, system 200 may include a number of different subsystems, databases, and/or libraries. In some arrangements, all of the databases included in system 200 may be included in and/or incorporated into a single computing device, while in other arrangements, each database included in system 200 (and/or combinations thereof) may be included in and/or incorporated into a distinct and/or dedicated computing device.

As seen in FIG. 2, in some embodiments, locator system 200 may include a decision engine 205. Decision engine 205 may be configured to receive various types of information, such as location service information 210, transaction center status information 215 and user device data requests 220. Decision engine 205 may additionally be configured to store and/or utilize information associated with one or more business rules 230 (which may, e.g., be used by system 200 in responding to location information requests, as discussed below). In addition, decision engine 205 may be configured to send and/or exchange various types of information with one or more other devices, which may include sending one or more potential service options 225 to a user device. For instance, decision engine 205 may be configured to provide potential service options 225 to a user device based on and/or in response to a location information request received from the particular user device. This arrangement represents one example configuration of system 200. In other embodiments, one or more elements of system 200 may be combined and/or additional and/or alternative types of information and/or requests may be included and/or handled in addition to and/or instead of those shown in FIG. 2.

In some embodiments, decision engine 205 may be configured to collect and aggregate information. In one or more arrangements, the information that is collected and/or aggregated by decision engine 205 may include location service information 210. Location service information may include information about the one or more specific types of services that may be offered at various locations, including information about the types of services offered by an organization (e.g., the organization that is implementing system 200) at various retail locations that it may own and/or operate (e.g., banking services, loan services, administrative services, and the like). In some instances, decision engine 205 may receive location service information from another system (e.g., a transaction center monitoring system). Additionally or alternatively, decision engine 205 may receive location service information directly from a transaction center itself. For instance, some transaction centers may be ATMs, ATAs, and/or other automated transaction centers or computing devices that may be configured to periodically report information about the services that they provide and/or offer to the locator system 200, and locator system 200 may be configured to receive these periodic reports (e.g., hourly, daily, weekly, monthly, and so on) and store the information as location service information (which may, e.g., enable decision engine 205 to respond to location information requests received from various user devices using relatively up-to-date location service information).

Decision engine 205 may also be configured to collect and aggregate transaction center status information 215. Transaction center status information may include information about the accessibility and/or availability of specific services at specific transaction centers (which may, e.g., include general information about transaction center availability, information about the expected wait time(s) for specific service(s) at specific transaction center(s), information about specific service(s) that may be temporarily out-of-order and/or otherwise temporarily unavailable at specific transaction center(s), and the like). In some instances, decision engine 205 may receive transaction center status information from another system (e.g., a transaction center monitoring system). Additionally or alternatively, decision engine 205 may receive transaction center status information directly from a transaction center itself (and, e.g., such transaction center status information may indicate whether the transaction center is available for use). For example, some transaction centers may be ATMs, ATAs, and/or other automated transaction centers or computing devices that may be configured to periodically report information about the current availability status of the various services that they may be able to provide and/or offer to the locator system 200, and locator system 200 may be configured to receive these periodic reports (e.g., hourly, daily, weekly, monthly, and so on) and store the information as transaction center status information (which may, e.g., enable decision engine 205 to respond to location information requests received from various user devices using relatively up-to-date transaction center status information).

In some embodiments, decision engine 205 may be further configured to receive user device data requests. In one or more arrangements, such a data request may include a request for one or more potential and/or recommended locations at which the user of the user device may be able to access and/or obtain a defined service that may be offered by the organization implementing decision engine 205. For example, such a defined service may be a banking service, a loan service, an administrative service, and/or another type of service. In some instances, the data request that is received by decision engine 205 may be composed on a user device after a user of the user device selects a particular service that they would like to access, which in turn may cause the user device to generate and send the data request to decision engine 205 to obtain one or more potential and/or recommended locations at which the user may access the requested service. In this way, a customer of the organization may be able to more easily receive information that is pertinent to their needs. In particular, by prompting a user to provide information about their needs (e.g., based on customer queries such as “where can I get X accomplished,” “how do I set up and/or use Y,” “can I obtain more information about Z products and services,” and the like) using software running on a user device, and subsequently processing these queries at a decision engine implementing one or more aspects of the disclosure, an organization implementing the decision engine may be able to serve the customer by “meeting” them at the point at which they need services, rather than asking the customer to think about and select which particular services they need.

In some instances, the data requests that are received by decision engine 205 may also include location information about the user device(s) that are submitting such data requests. In particular, decision engine 205 may be configured to receive one or more data requests that include user device location information and take this information into account when providing one or more potential and/or recommended service options 225 in response to the various data requests (which may, e.g., include recommending that a user of a particular user device visit the transaction center that is closest to the current location of the user device and that is capable of and/or able to provide the user with the desired service(s)). The location information that may be included in various data requests may be expressed as geographic coordinates (which may, e.g., be obtained using a global positioning system (GPS) receiver included in the user device submitting the location service request) and/or as a network address (which may, e.g., be a network address assigned to and/or otherwise corresponding to the user device submitting the location service request, such as an internet protocol (IP) address that has been assigned to the user device, as this information may also be indicative of the user device's current location and can be analyzed by decision engine 205 to determine the user device's current location).

In one or more arrangements, decision engine 205 may be configured to generate one or more service options in response to the various data requests that it may receive. With respect to a particular data request, generating one or more service options may, for example, be based on any and/or all of the the information that the decision engine 205 may receive in connection with the data request, including user device location information, as well as any and/or all of the location service information, transaction center status information, and/or other information that the decision engine 205 may collect, aggregate, update, store, and/or otherwise maintain. Decision engine 205 may also be configured to store and/or utilize information associated with one or more predetermined business rules 230 in generating service options responsive to various user requests. For example, the business rules 230 may be configured to cause the decision engine 205 to recommend relatively low-cost and/or high-efficiency options in response to various user requests over other potential options. In particular, the business rules 230 may include per-unit cost information about various transaction centers and/or the various services that may be offered at various transaction centers, and the business rules 230 may be configured to cause the decision engine 205 to recommend and/or otherwise steer customers towards specific transaction center(s) that not only meet the customers' needs in terms of services desired in connection with specific user request(s), but also are able to provide customers with the desired services at the lowest cost to the organization that may provide such services, relative to other transaction centers that may be able to provide the same services but at a higher cost to the organization. In some instances, predetermined policies that may be included in the business rules 230 may be configurable by the organization to meet various transaction requirements. Additionally or alternatively, the business rules 230 may include observations, analysis, and/or other information that may have been previously gained by analysts and/or computer-implemented processes, including cost breakdown information that may inform the selection of low-cost transaction centers when decision engine 205 is receiving, responding to, and/or otherwise processing various user device data requests 220. In addition, the business rules 230 may be cross-referenced with output from one or more other applications, such as one or more account applications, one or more cost management applications, and/or one or more other applications.

In some instances, decision engine 205 may be further configured to provide one or more generated options 225 to user device(s) that have may have submitted data requests 220 to the decision engine 205. Decision engine 205 may, for instance, provide one or more options 225 based on the aggregated information (which may, e.g., include location service information 210 and transaction center status information 215) and in response to receiving the data request. In addition, the one or more options 225 may, for example, include location information identifying at least one recommended transaction center that provides the service(s) desired by the user of the user device who submitted the data request. For example, in generating options 225 and subsequently providing them to the user device, the decision engine 205 may analyze the location information received from the user device, determine what transaction center(s) are closest to the user device and capable of providing the required service(s) to the user based on the location service information 210, then determine which of these transaction center(s) are currently able to provide such service(s) to the user (e.g., in the most efficient fashion, with the shortest wait time for the user, and/or the like) based on the transaction center status information 215, and then determine which of these transaction center(s) are able to provide such service(s) at the lowest cost to the organization operating the transaction center(s) and/or providing the service(s) to the user. In performing this three-step analysis, the decision engine 205 may produce a ranked listing of transaction center(s) that can service the user's needs, and this ranked listing may be provided to the user device as the service options 225. In addition, in the ranked listing, the highest priority transaction center may be the transaction center that is the closest to the current location of the user device and capable of providing the required service(s) (e.g., as based on the location information for the user device and the location service information), having the shortest wait time and/or otherwise most able to efficiently provide the customer with the require service(s) (e.g., as based on the transaction center status information), and having the lowest cost to the organization in providing the required service(s) to the customer (e.g., as based on the business rules 230).

As indicated above, these are examples of the elements that may be included in system 200 in some embodiments, as well as some of the functions that may be performed (e.g., by system 200). In other embodiments, additional and/or other elements may similarly be included and/or other functions may be performed, in addition to and/or instead of those discussed above.

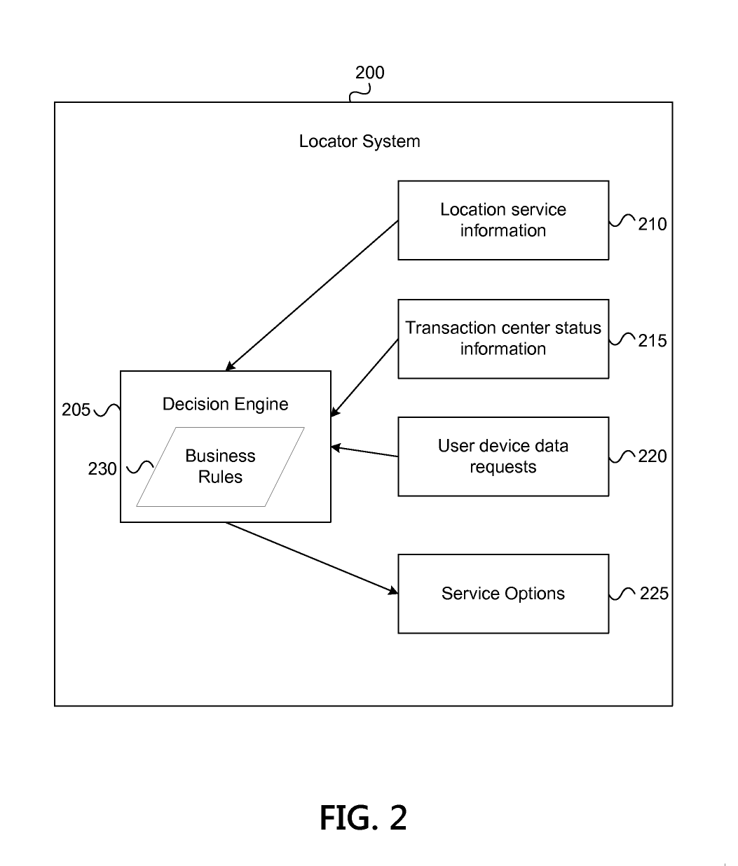

Having described an example system that may be used in receiving and processing location requests in some embodiments, an example of a method that may, in some embodiments, be performed (e.g., by such a system 200; by another computing device, such as computing device 101; and/or the like) will now be discussed in greater detail with respect to FIG. 3.

FIG. 3 illustrates a flowchart that depicts a method of receiving and processing location requests according to one or more embodiments. In some embodiments, the example method illustrated in FIG. 3 may be performed by a computing device, which may include and/or implement one or more aspects of computing device 101. In additional and/or alternative embodiments, the example method illustrated in FIG. 3 may be performed by a computer system, such as system 200. In other embodiments, the example method illustrated in FIG. 3 may be implemented in and/or may otherwise be embodied in computer-readable instructions that may be stored in a computer-readable medium, such as a memory.

As seen in FIG. 3, the method may be initiated in step 305, in which location service information and transaction center status information may be aggregated. For example, in step 305, a computing device (e.g., computing device 101, system 200, and/or the like) may aggregate location service information and transaction center status information. The location service information aggregated in step 305 may, for instance, include information identifying one or more services that are available at each of a plurality of enterprise locations. The transaction center status information aggregated in step 305 may, for instance, include information identifying a current status of one or more transaction centers at each of the plurality of enterprise locations. In aggregating the location service information and the transaction center status information, the computing device may, for example, receive location service information from a variety of different sources (e.g., from one or more databases and/or other data sources that are maintained by the organization about the capabilities of and/or services offered at different transaction centers, by directly interrogating computing devices at various transaction centers and receiving service capability information from these transaction center computing devices themselves, as user input entered manually by a user of the computing device, and/or from one or more other sources). Additionally or alternatively, the computing device may receive transaction center status information from a number of different sources (e.g., from one or more databases and/or other data sources that are maintained by the organization about the current status of various service channels at different transaction centers, by directly interrogating computing devices at various transaction centers and receiving status information from these transaction center computing devices themselves, as user input entered manually by a user of the computing device, and/or from one or more other sources).

In some instances, the location service information may identify one or more services that are available at each of a plurality of enterprise locations, which may include various retail locations that are owned and/or operated by the organization, as well as other locations at which the organization may offer and/or provide various services to customers and potential customers. For example, the organization may offer and/or provide banking services, loan services, administrative services and/or the like, and the location service information may identify specific locations at which some or all of these services may be obtained by customers and potential customers of the organization. In some instances, the location service information thus may identify specific locations at which various types of banking services may be offered, provided, and/or otherwise made available, including specific locations where a customer or potential customer of the organization may receive a check deposit, receive a cash deposit, receive a cash withdrawal, request a cashier's check, and/or obtain other services. Additionally or alternatively, the location service information may identify specific locations at which various types of loan services may be offered, provided, and/or otherwise made available, including specific locations where a home equity loan request can be processed, specific locations where a car loan request can be processed, specific locations where a home mortgage request can be processed, and/or specific locations where other types of requests can be processed. Additionally or alternatively, the location service information may identify specific locations at which various types of administrative services may be offered, provided, and/or otherwise made available, including specific locations where a request for a new bank card may be received, a request to modify a bank account holder's account profile information may be received, and/or other similar types of requests may be received.

In some arrangements, the transaction center status information may identify a current status of one or more transaction centers at each of a plurality of enterprise locations, which, as indicated above, may include various retail locations that are owned and/or operated by the organization, as well as other locations at which the organization may offer and/or provide various services to customers and potential customers. For example, the transaction center status information may include real-time or near real-time availability information for one or more transaction centers. This real-time availability information may, for instance, include information about the operating hours of specific transaction centers, whether specific transaction centers are wholly or partially out of order, whether specific transaction centers are temporarily closed for maintenance, and/or the like.

In step 310, a data request may be received from a user device. For example, in step 310, the computing device may receive a data request from a user device. The data request may be a request for a location at which the user of the user device may be able to perform a defined service (e.g., a banking service, a loan service, an administrative service and the like). In some instances, the requested service may be selected from a drop-down menu displayed on the user device. The user device may be a mobile device (e.g., a smart phone, a tablet computer, and the like) or a desktop computing device.

In some aspects, the data request may include location information for the user device at the time of the data request. For example, the location information may be automatically collected by the user device and transmitted to the decision engine from the user device along with the data request in step 310. The location information may, for instance, include a network address (e.g., an IP address), geographic coordinates (which may, e.g., be obtained from a GPS receiver or other positioning system), and/or the like. In alternative instances, the location information may be manually entered on a user device (e.g., by the user of the user device) and then transmitted to the decision engine along with the data request. For example, a user may manually enter location information, such as their current street address, city/state, zip code and the like.

In step 315, one or more options may be provided. For example, in step 315, the computing device may provide one or more potential service options in response to a data request received in step 310. In some instances, the computing device may determine, select, rank, and subsequently provide the potential service options based on the location service information and the transaction center status information that may, for instance, have been aggregated in step 305. Additionally or alternatively, the computing device may determine, select, rank, and subsequently provide the potential service options based on one or more business rules. The potential service options that are provided by the decision engine may, in some instances, include location information for a transaction center where a defined service may be performed. For example, the potential service options may include location information specifying the address and/or other information identifying the location of one or more specific transaction centers that have been selected by the computing device and that satisfy the data request received from the user device (e.g., in step 310). In some instances, the information that is provided to the user device (e.g., in step 315) by the computing device may also include information about specific attributes for the identified transaction centers (which may, e.g., indicate the availability of night drop services, notary services, coin deposit services, money exchange services, and the like), transaction center data elements (which may, e.g., indicate the hours of operation for a particular transaction center, the address of a particular transaction center, and the like), and transaction center event information (which may, e.g., include scheduling information about various events that may be planned at a particular transaction center, including charity drives, open house, community events, and the like).

In some arrangements, aspects of the disclosure may enable a user device to provide additional and/or alternative features. For example, in sending a data request to the decision engine (which may, e.g., be received in step 310, as discussed above), a user device may provide mobile check-in information about a transaction center in which the user device may be currently located. This mobile check-in information may, for instance, enable the computing device in managing capacity, tracking visits, and recording and/or reporting status information for the particular transaction center. Additionally or alternatively, the computing device may update the transaction center status information (which may, e.g., be aggregated by the computing device in step 305, as discussed above) based on such mobile check-in information.

In some instances, in addition to providing one or more potential service options to the user device in step 315, the computing device additionally or alternatively may provide one or more location-based promotions to the user device, which may be configured to be displayed on the user device when the user device is located within a predetermined distance of the transaction center. Similar features may be implemented to provide bank-by-appointment services and/or otherwise provide the user of the user device with a personalized experience while they may be visiting a particular transaction center. Additionally or alternatively, the computing device may, in step 315, additionally or alternatively provide notifications (e.g., push notifications and/or other information) to the user device about current wait time at particular transaction center(s), appointment reminders, sales information, promotion information, online chat functions, and/or activity feed information (which may, e.g., include promotions and/or news about particular transaction center(s) within a predetermined distance of the current location of the user device).

Subsequently, the method may end. As illustrated in the examples above, however, certain aspects of the receiving and processing location information requests may be repeated (e.g., in receiving, updating and continuing to aggregate location service information and transaction center status information). Additionally or alternatively, the decision engine may perform similar steps as those illustrated in FIG. 3 and discussed above in receiving and processing other location information requests.

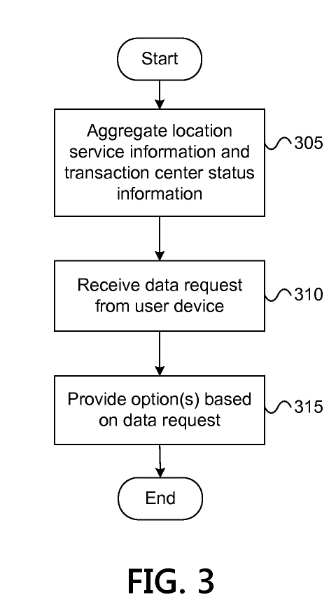

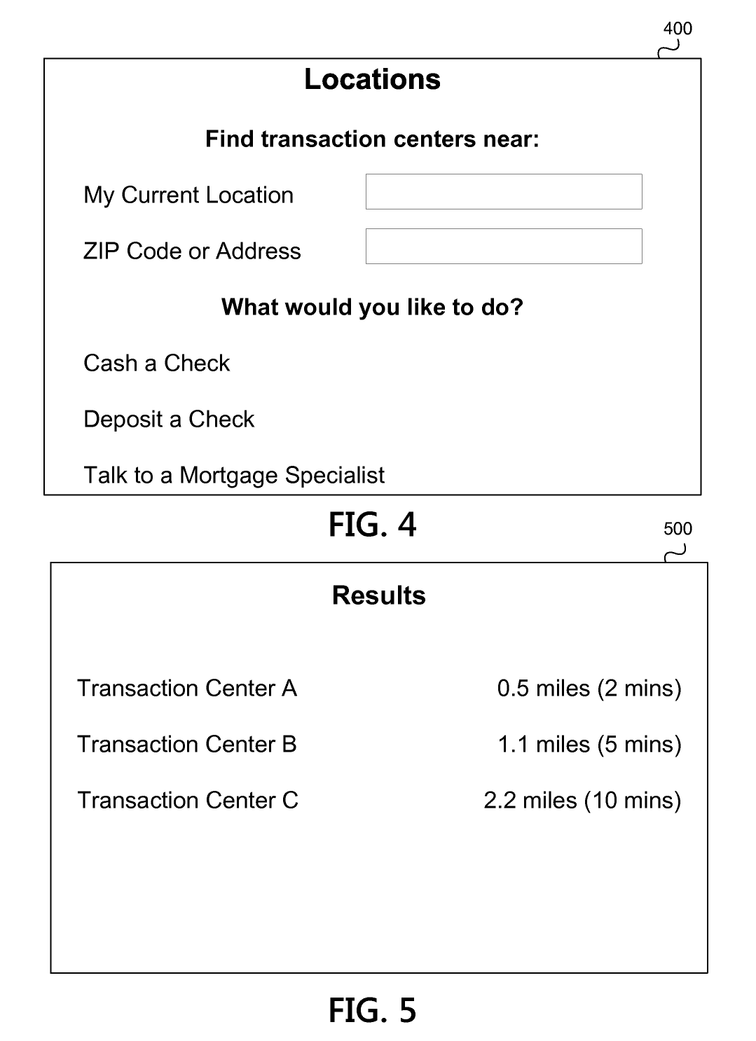

Having described several examples of the processing that may be performed by a decision engine in receiving and processing location information requests in some embodiments, several example user interfaces that might be displayed and/or otherwise provided by a user device, in transmitting data requests and receiving options will now be discussed with respect to FIGS. 4-5.

FIG. 4 illustrates an example of a user interface that may be displayed when a user composes a data request in one or more embodiments. As seen in FIG. 4, in some instances, a user device implementing one or more aspects of the disclosure may display and/or otherwise provide a user interface 400 to make various selections that may define and/or form part of a data request that may be sent to a decision engine (e.g., as in the examples discussed above).

In some arrangements, user interface 400 may include a menu that is configured to allow a user to select a service that they may wish to obtain from an organization (e.g., a banking service, a loan service, an administrative service and the like). Additionally or alternatively, user interface 400 may include one or more controls that are configured to allow the user to enter their current location (e.g., street address, city/state, zip code, and the like) to facilitate creation of the data request (e.g., as in the examples discussed above) and/or one or more controls that are configured to allow the user to command the user device to determine and/or use its current location automatically.

FIG. 5 illustrates another example of a user interface that may be displayed upon receiving provided options from a decision engine in one or more embodiments. As seen in FIG. 5, in some instances a user device implementing one or more aspects of the disclosure may display and/or otherwise provide a user interface 500 to present one or more potential service options to a user of the user device (e.g., after receiving such potential service options from a decision engine, as in the examples discussed above).

In some arrangements, user interface 500 may include a list of transaction centers at which the user may obtain the desired service(s) (e.g., the service(s) with respect to which the user composed the data request in the examples discussed above in connection with FIG. 4). For example, the list of transaction centers in user interface 500 may identify the type of each transaction center (e.g., ATM, ATA, banking center, and the like), as well as other information about each transaction center, such as the types of services that are offered and/or provided at each particular transaction center. Additionally or alternatively, the screen may display distance information for each identified transaction center (e.g., mileage from current user device location to each transaction center, such as, 0.5 miles, 1.1 miles, 2.2 miles and the like or estimated travel time from user device location to transaction center).

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable memory. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, the steps illustrated in the figures may be performed in other than the recited order, and one or more steps illustrated may be optional in accordance with aspects of the disclosure.

What is claimed is:

1. A method comprising:
aggregating, by a decision engine being executed on one or more server computing devices, location service information and transaction center status information, the location service information identifying one or more services that are available at each of a plurality of enterprise locations, and the transaction center status information identifying a current status of one or more transaction centers at each of the plurality of enterprise locations;
receiving, by the decision engine, from a user device, a data request for a location to perform a defined service, the data request including location information for the user device at the time of the data request; and
in response to receiving the data request, providing, by the decision engine, one or more options to the user device based on the location service information and the transaction center status information.

2. The method of claim 1, wherein the one or more services that are available at each of the plurality of enterprise locations include at least one of: banking services, loan services, and administrative services.

3. The method of claim 2, wherein the banking services include at least one of: receiving a check deposit, receiving a cash deposit, issuing a cash withdrawal, and receiving a request for a cashier's check.

4. The method of claim 2, wherein the loan services include at least one of: processing a home equity loan request, processing a car loan request, and processing a home mortgage request.

5. The method of claim 2, wherein the administrative services include at least one of: receiving a request for a new bank card and receiving a request to modify a bank account holder's account profile information.

6. The method of claim 1, wherein the decision engine provides the one or more options to the user device further based on one or more business rules.

7. The method of claim 1, wherein the transaction center status information includes real-time or near real-time availability information for the one or more transaction centers.

8. The method of claim 1, wherein at least one transaction center of the one or more transaction centers comprises at least one of: an automated teller machine, an automated teller assistant, and a banking center.

9. A computing device, comprising:
at least one processor; and
memory storing computer readable instructions that, when executed by the at least one processor, cause the computing device to:
aggregate, by a decision engine being executed on the computing device, location service information and transaction center status information, the location service information identifying one or more services that are available at each of a plurality of enterprise locations, and the transaction center status information identifying a current status of one or more transaction centers at each of the plurality of enterprise locations;
receive, by the decision engine, from a user device, a data request for a location to perform a defined service, the data request including location information for the user device at the time of the data request; and
in response to receiving the data request, provide, by the decision engine, one or more options to the user device based on the location service information and the transaction center status information.

10. The computing device of claim 9, wherein the one or more services that are available at each of the plurality of enterprise locations include at least one of: banking services, loan services, and administrative services.

11. The computing device of claim 10, wherein the banking services includes at least one of: receiving a check deposit, receiving a cash deposit, issuing a cash withdrawal, and receiving a request for a cashier's check.

12. The computing device of claim 10, wherein the loan services include at least one of: processing a home equity loan request, processing a car loan request, and processing a home mortgage request.

13. The computing device of claim 10, wherein the administrative services include at least one of: receiving a request for a new bank card and receiving a request to modify a bank account holder's account profile information.

14. The computing device of claim 9, wherein the decision engine is configured to provide the one or more options to the user device further based on one or more business rules.

15. The computing device of claim 9, wherein the transaction center status information includes real-time or near real-time availability information for the one or more transaction centers.

16. The computing device of claim 9, wherein at least one transaction center of the one or more transaction centers comprises at least one of: an automated teller machine, an automated teller assistant, and a banking center.

17. One or more non-transitory computer-readable media having computer-executable instructions stored thereon that, when executed by a computing device, cause the computing device to:
aggregate, by a decision engine that is configured to be executed on the computing device, location service information and transaction center status information, the location service information identifying one or more services that are available at each of a plurality of enterprise locations, and the transaction center status information identifying a current status of one or more transaction centers at each of the plurality of enterprise locations;
receive, by the decision engine, from a user device, a data request for a location to perform a defined service, the data request including location information for the user device at the time of the data request; and
in response to receiving the data request, provide, by the decision engine, from a user device, one or more options to the user device based on the location service information and the transaction center status information.

18. The one or more non-transitory computer-readable media of claim 17, wherein the one or more services that are available at each of the plurality of enterprise locations include at least one of: banking services, loan services, and administrative services.

19. The one or more non-transitory computer-readable media of claim 18, wherein the banking services include at least one of: receiving a check deposit, receiving a cash deposit, issuing a cash withdrawal, and receiving a request for a cashier's check.

20. The one or more non-transitory computer-readable media of claim 18, wherein the loan services include at least one of: processing a home equity loan request, processing a car loan request, and processing a home mortgage request.
